(19) United States
(12) Patent Application Publication
(10) Pub. No.: US 2008/0177614 A1
(43) Pub. Date: Jul. 24, 2008

(54) METHOD AND SYSTEM FOR ESTIMATING DYNAMICS OF WORKFORCE ABSENTEEISM USING INFORMATION ON PANDEMIC SPREAD AND MITIGATION ACTIONS

(76) Inventors: Lianjun An, Yorktown Heights, NY (US); Stephen John Buckley, White Plains, NY (US); Young Min Lee, Old Westbury, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/626,452

(22) Filed: Jan. 24, 2007

(51) Int. Cl. G06F 9/46

(52) U.S. Cl. 705/9

(57) ABSTRACT

The present invention provides a method and system estimating the likelihood of employees not being available for work as a result of pandemic occurrence and effectiveness of related mitigation actions. The invention allows users to assess the impact of pandemic on availability of corporate workforce and to estimate the effectiveness of various corporate mitigation actions in terms of how such actions may reduce the adverse effects of a pandemic on employee availability by incorporating information on infection rate, perception, needs for family care and infrastructure availability into a system of algebraic and differential equations.

### BACKGROUND OF THE INVENTION

1. Field of the Invention

The present invention generally relates to estimating the occurrence and dynamics of workforce absenteeism resulting from pandemic events, human behavior and mitigating policies. More particularly, the present invention relates to using an epidemiological model of pandemic combined with a causal model of human behavior and mitigation actions to reduce the likelihood of employees being unavailable for work.

2. Background Description

There is a high likelihood that a pandemic will occur in the not-too-distant future and that it will impact various aspects of society—creating deaths, despair, fear, and monetary cost, among other losses. Firms would also be negatively affected by a pandemic through loss of revenue, profit, employees, and even through a reduction in the value of the business itself.

Employee absenteeism is a key factor that impacts firms as result of a pandemic, hampering various business operations, especially for service-intensive businesses. During and even after a pandemic, some employees would not be available for work because of various factors including, but not limited to, sickness arising from the affliction, death, perception of risk, the need to attend to family members and non-availability of infrastructure, among other factors. Such a situation would create workforce shortfalls hampering manufacturing, the delivery of goods, and the provision of services.

There has been prior art describing the epidemiological spread of pandemic with respect to time and geography using mathematical equations, e.g., a system of differential equations. There has also been prior art making use of models of how the epidemiological spread of pandemic may change human behavior (causing fear, perception of risk, flight, etc.) using causal relationship and dynamic modeling methods.

The prior art has not, however, made use of models of how countermeasures may have a mitigating effect, not only on the epidemiological infection of employees but also on the perception of employees as to the risk of epidemiological infection. Both the size of the infectious population and the perception of risk affect employee absenteeism.

### SUMMARY OF THE INVENTION

To address the deficiencies of the prior art, the present invention models the effect of mitigation actions on employee absenteeism and provides visibility into how mitigation actions may offset the effect of the epidemiological spread of a pandemic.

The present invention uses an epidemiological model; for instance, SEIR (Susceptible, Exposed, Infectious and Recovered) model, etc. of pandemic and various corporate mitigation actions, estimating absenteeism (and thus availability) of employees as combined effect of pandemic (increasing effect on absenteeism) and mitigation actions (decreasing effect on absenteeism). An epidemiological model produces information on population affected by pandemic (susceptible, exposed, infectious, recovered population etc.), which affect employee health, perception and fear, which in turn cause employee absenteeism.

Mitigation actions to reduce the effect of pandemic by reducing transmissibility, duration of infectivity and perception of risk may include, but are not limited to: distributing anti-viral drugs such as Tamiflu®; distributing face masks; instituting separation policies; closing sites; restricting travel; using ancillary workers; using improved hygiene; instituting employee monitoring programs; reducing absence payments; and providing vaccination. Deployment of multiple mitigation actions may have a compounding effect on reducing absenteeism by affecting two major factors; reduction of number of infectious employees and reduction of the perception of employees as to the risk of infection.

To prepare firms for the possibility of pandemic, and to position firms to be able to develop response plans, it is very important to enable firms to estimate the magnitude and dynamics of workforce absenteeism prior to an occurrence of pandemic. It is also important to enable firms to estimate the effectiveness of various mitigation actions in terms of how such actions may reduce the adverse effects of a pandemic on employee availability and productivity. The present invention can be used to assist business leaders in assessing the impact of pandemic on availability of corporate workforce. An objective of the present invention is thus to quantify the impact of a potential pandemic on corporate employee absenteeism, including the effect of mitigation actions that firms may implement.

In the present invention, absenteeism is estimated as a function of perceived risk and the number of infectious employees, as well as other factors, including, but not limited to, the number of employees missing work to attend to family needs, the availability of infrastructure, and so forth, as shown in Equation 1 in a form of algebraic equation as,

Aₜ=f(Pₜ,Iₜ,Fₜ,Sₜ) (Equation 1)

where
Aₜ=Absenteeism at time t
Pₜ=Perception of risk at time t
Iₜ=Number of infectious employees at time t
Fₜ=Family needs at time t
Sₜ=Infrastructure availability at time t
   The perception of risk, Pₜ, at time t, in the equation 1 above, is in turn expressed as, but not limited to,

$${P}_{t} = \{ {\int }_{{t}_{0}}^{t} ( {F}_{i} - {F}_{d} ) \cdot d t \} \cdot W \cdot {R}_{motality} \cdot {α}_{p} \cdot {Eff}_{mit} \qquad ( Equation 2 )$$

where
Fᵢ=increasing rate of fear=[a·Iₜ−F_{c}]⁺
F_{d}=decreasing rate of fear=F_{c}/τ
a=a coefficient
Iₜ=infectious population at time t
F_{c}=cumulated fear
τ=duration of fear
W=warning factor=f(W_{media}, W_{gov})
W_{media}=media warning factor of pandemic
W_{gov}=government warning factor of pandemic
R_{mortality}=mortality rate
aₚ=coefficient for effectiveness of overall mitigation actions on perception
Effₘᵢₜ=effectiveness of overall mitigation actions
   The number of infectious employees, Iₜ, at time t in Equation 1 above is modeled as a fraction of infectious general population reduced by the effectiveness of mitigation actions.

Iₜ=Iₜ^{g}·αᵢ·Effₘᵢₜ (Equation 3)

where
Iₜ^{g}=Number of infectious general population
αᵢ=coefficient for effectiveness of overall mitigation actions on infectious employees

The effectiveness of overall mitigation actions is computed as a compounded effect of individual mitigation action as shown below.

$${Eff}_{mit} = {\prod }_{i = 1}^{N} ( 1 - {eff}_{i} \cdot {avail}_{i} ) \qquad ( Equation 4 )$$

where
effᵢ=effectiveness of individual mitigation action i
availᵢ=availability of individual mitigation action i
N=total number of mitigation actions

The present invention thus provides a method, a system, and a machine-readable medium with computer instructions for estimating workforce absenteeism comprising the steps of: using a computer to access an epidemiological model of pandemic; using a computer to determine a compounded effect of one or more mitigation actions; using a computer to estimate overall workforce absenteeism based on perceived risk of pandemic, expected number of infectious employees, expected number of employees attending family needs, and infrastructure availability; and using a computer to provide said estimate of overall workforce absenteeism as output to a peripheral device.

According to the present invention, the effect of one or more mitigation actions may be computed by multiplying effectiveness and availability of individual mitigation actions. In addition, the overall effectiveness of mitigation actions may be a factor in determining one or a plurality of (a) the expected perception of employees as to the risk of infection and (b) the expected number of infectious employees. Furthermore, workforce absenteeism may be estimated based on expected employee perception of the risk of pandemic, expected number of infectious employees, expected number of employees attending family needs, and expected infrastructure availability.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an overview for estimating workforce absenteeism according to the present invention.

FIG. 2 shows an overview of causal relationships according to the present invention.

FIG. 3 shows a detail of causal relationships according to the present invention.

FIG. 4 shows sample absenteeism output from the model without any mitigation action according to the present invention.

FIG. 5 shows sample absenteeism output from the model with some mitigation actions according to the present invention.

### DETAILED DESCRIPTION OF THE PREFERRED EMBODIMENTS OF THE INVENTION

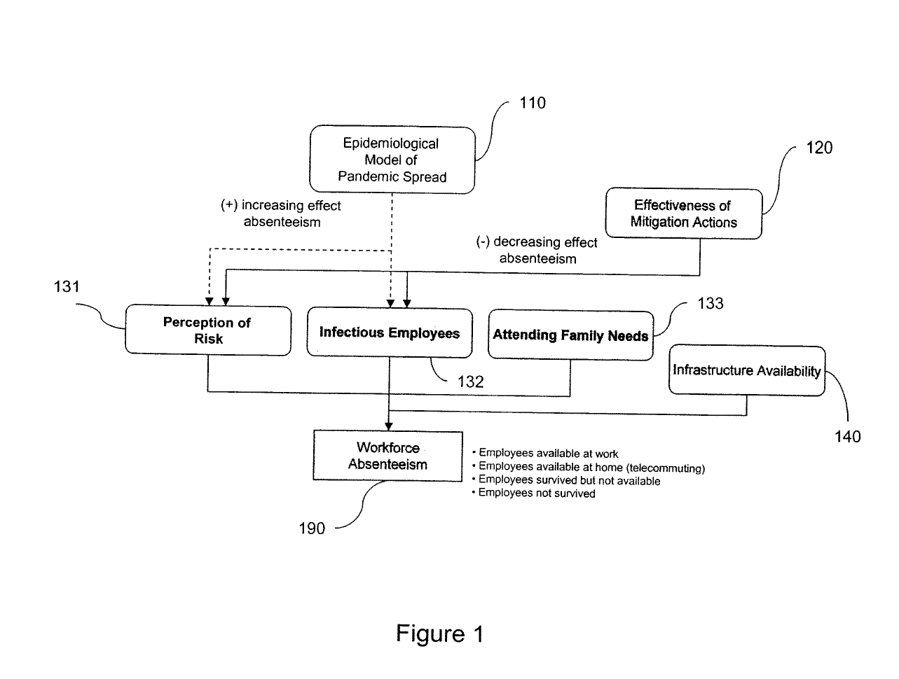

Referring now to the drawings, and more particularly to FIG. 1, there is shown an overview for estimating workforce absenteeism according to the present invention. An epidemiological model of pandemic for an infectious population 110 is accessed, which may be done using a computer connected to system on which the model or database of modeling results is stored. Using the epidemiological model, a determination is made as to the degree of perceived risk 131 and infectious population 132. The epidemiological spread of pandemic 110 has increasing effect on perceived risk and infectious population. The overall effectiveness of mitigation actions 120 is calculated from effectiveness and availability of individual mitigation action. The overall effectiveness of mitigation actions has the decreasing effect on the perceived risk 131 and infectious population 132. Therefore, the balance between pandemic spread 110 (increasing effect) and the effectiveness of mitigation actions 120 (decreasing effect) would determine the overall level of perceived risk 131 and infectious employee population 132. When one or more of mitigation actions is deployed, the number of infectious employees 132 would be less than the number of infectious general population.

Needs to attend infectious family member 132 are computed using the information on degree of pandemic spread and average family size in region of the analysis. The infrastructure availability is accessed from another model that describes the unavailability of infrastructure such as electricity, water, telecommunication etc, as a result of pandemic.

Overall workforce absenteeism 190 may then be determined based on: perceived risk of pandemic 131; expected number of infectious employees 132; expected number of employees attending family needs 133; and infrastructure availability 140. A resulting estimate of overall workforce absenteeism 190 may then be provided as output to a peripheral device. The workforce absenteeism is computed in four groups; number of employees available at work, number of employees available at home (telecommuting), number of employees survived but not available for work, and number of employees not survived.

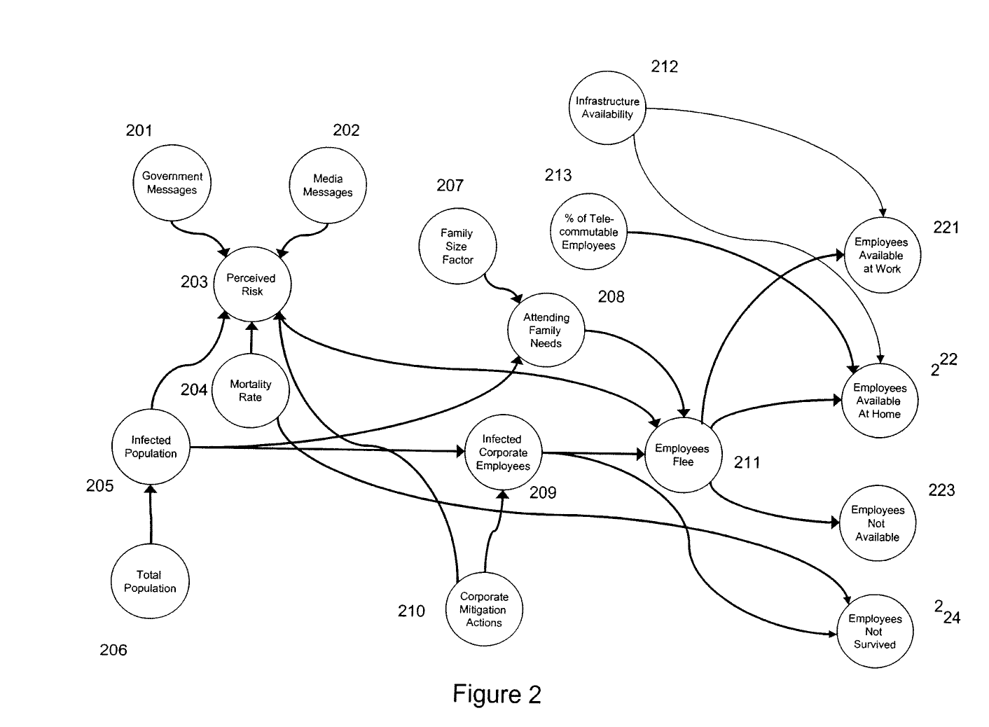

FIG. 2 shows an overview of causal relationships according to the present invention. Received risk 203 is affected by infectious population (general) 205, mortality rate 204, government warning (message) 201, media warning (message) 202 and corporate mitigation actions 210. The number of infectious corporate employees 209 is a fraction of infected general population, and is discounted by the effectiveness of corporate mitigation action 210. The needs to attend infectious family 208 are affected by the number of infectious population 205 and family size factor 207 of a geographical region of interest. The number of employees who decide to flee from job/work 211 depends on, but is not limited to; infectious employees 209, perceived risk 203, and attending family needs 208. Some employees do not survive pandemic, and the number is affected by number of infectious employees 209 and mortality rate 204. The number of employees who flee affects the number of employees available at work 221, the number of employees available at home (telecommuting), and the number of employees not available. Availability of infrastructure (electricity and telecommunication etc.) affects the number of employees available at work 221 and at home 222. The percentage of tele-commutable employees 213 also affects the number of employees who are available at home 222. The number of employees not survived 224 is affected by number infectious employees 209 and mortality rate 204.

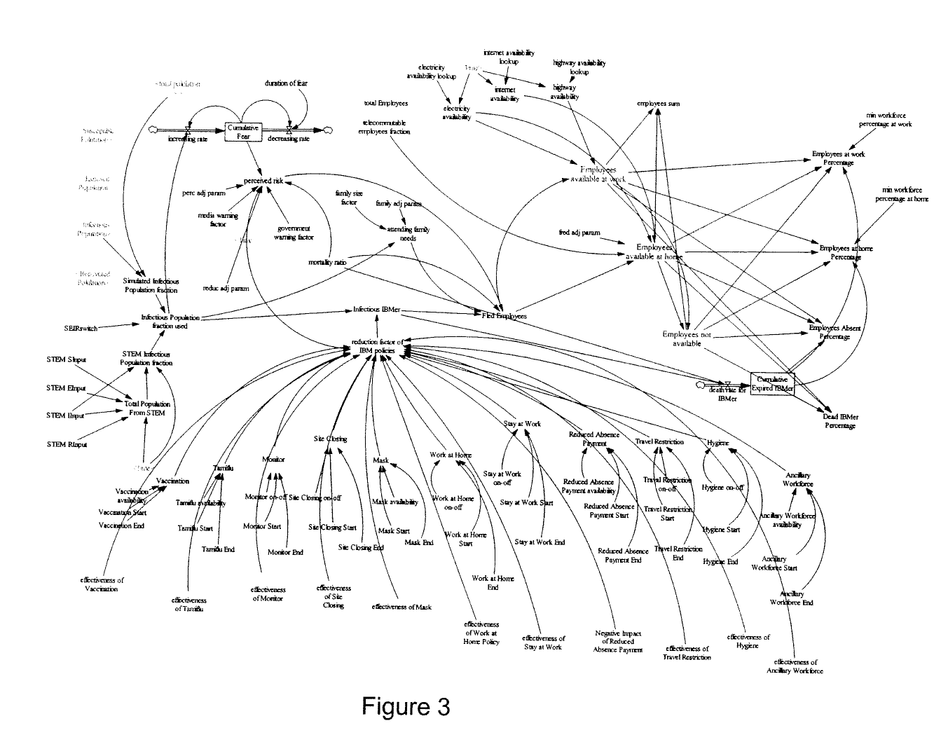

FIG. 3 shows more details of causal relationships described above for the FIG. 2 according to the present invention. The bottom portion of FIG. 3 also shows individual mitigation actions.

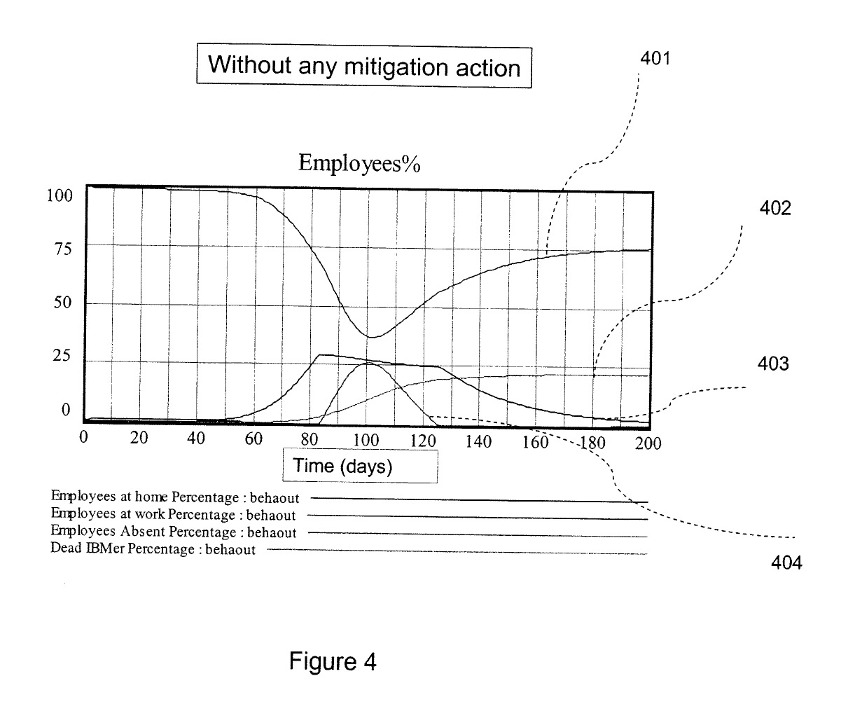

FIG. 4 shows sample output from the model according to the present invention without any mitigation action. The line 401 describes the percentage of employees available at work during 200 days of pandemic occurrence. The line 402 describes the percentage of employees who do not survive the pandemic. The line 403 describes the percentage of employees available at home (for telecommuting). The line 404 describes the percentage of employees who survive the pandemic but not available.

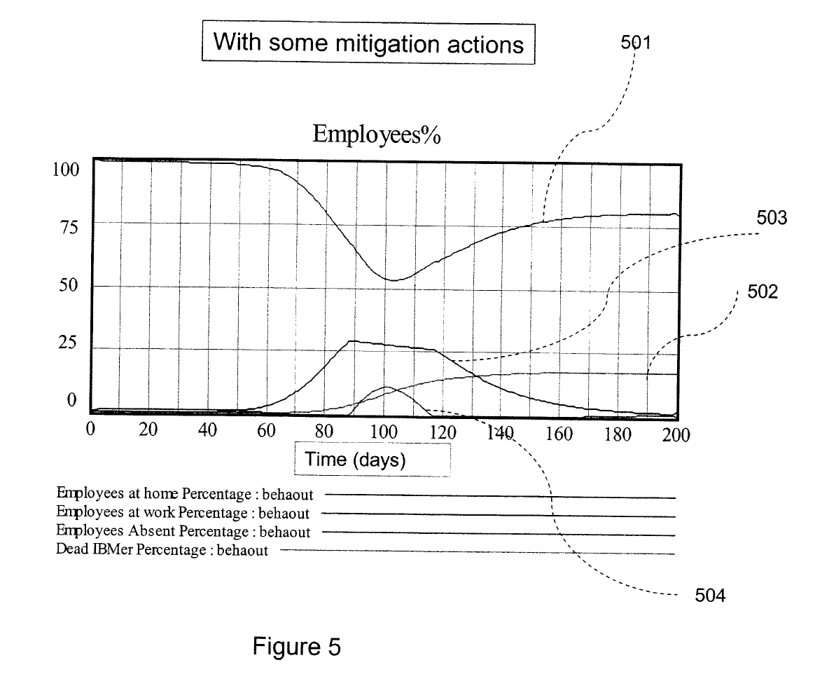

FIG. 5 shows sample output from the model with some mitigation actions. The line 501 describes the percentage of employees available at work during 200 days of pandemic occurrence. The line 502 describes the percentage of employees who do not survive the pandemic. The line 503 describes the percentage of employees available at home (for telecommuting). The line 504 describes the percentage of employees who survive the pandemic but not available.

A comparison of the outputs shown in FIG. 4 and FIG. 5 may be used by a firm to determine which mitigation action, or combination of mitigation actions, would provide the greatest potential for reducing absenteeism in the event of a pandemic.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A method for estimating workforce absenteeism comprising the steps of:
using a computer to access an epidemiological model of pandemic for number of infectious population;
using a computer to determine a compounded effect of one or a plurality of mitigation actions;
using a computer to estimate overall workforce absenteeism based on at least one of
expected employee perception of the risk of pandemic,
expected number of infectious employees,
expected number of employees attending family needs, and
expected infrastructure availability; and
using a computer to provide said estimate of overall workforce absenteeism as output to a peripheral device.

2. The method of claim 1, wherein said effect of one or a plurality of mitigation actions is computed by multiplying effectiveness and availability of individual mitigation actions.

3. The method of claim 1, wherein the impact of mitigation actions is a factor in determining one or a plurality of expected employee perception of risk and expected number of infectious employees.

4. The method of claim 1, wherein a computer is used to estimate workforce absenteeism based on at least one of
expected employee perception of the risk of pandemic,
expected number of infectious employees,
expected number of employees attending family needs, and
expected infrastructure availability.

5. The method of claim 1, wherein the workforce absenteeism is computed in at least one of four groups of employees;
number of employees available at work,
number of employees available at home (telecommuting),
number of employees survived but not available for work, and
number of employees not survived.

6. A system for estimating workforce absenteeism wherein there is provided:
a computer connected to an epidemiological model of pandemic for an infectious population;
a computer determining a compounded effect of one or a plurality of mitigation actions;
a computer estimating overall workforce absenteeism based on at least one of
expected employee perception of the risk of pandemic,
expected number of infectious employees,
expected number of employees attending family needs, and
expected infrastructure availability; and
a computer providing said estimate of overall workforce absenteeism as output to a peripheral device.

7. The system of claim 6, wherein a computer is provided to estimate workforce absenteeism based on at least one of
expected employee perception of the risk of pandemic,
expected number of infectious employees,
expected number of employees attending family needs, and
expected infrastructure availability.

8. The system of claim 6, wherein the workforce absenteeism is computed in at least one of four groups of employees;
number of employees available at work,
number of employees available at home (telecommuting),
number of employees survived but not available for work, and
number of employees not survived.

9. A machine-readable medium for estimating workforce absenteeism on which is provided:
machine-readable instructions for a computer to access a database with an epidemiological model of pandemic for an infectious population;
machine-readable instructions for a computer to determine a compounded effect of one or a plurality of mitigation actions;
machine-readable instructions for a computer to estimate overall workforce absenteeism based on at least one of
expected perception of the risk of pandemic,
expected number of infectious employees,
expected number of employees attending family needs, and
expected infrastructure availability; and
machine-readable instructions for a computer to provide said estimate of overall workforce absenteeism as output to a peripheral device.

10. The machine-readable medium of claim 9, wherein said effect of one or a plurality of mitigation actions is computed by multiplying effectiveness and availability of individual mitigation actions.

11. The machine-readable medium of claim 9, wherein the impact of mitigation actions is a factor in determining one or a plurality of expected employee perception of risk and expected number of infectious employees.

12. The machine-readable medium of claim 9, wherein machine-readable instructions are provided for a computer to estimate workforce absenteeism based on at least one of
expected employee perception of the risk of pandemic,
expected number of infectious employees
expected number of employees attending family needs, and
expected infrastructure availability.
